(19) United States
(12) Patent Application Publication
(10) Pub. No.: US 2020/0257233 A1
(43) Pub. Date: Aug. 13, 2020

(54) IMAGE FORMING APPARATUS

(71) Applicant: CANON KABUSHIKI KAISHA, Tokyo (JP)

(72) Inventor: Tomoki Baba, Kashiwa-shi (JP)

(21) Appl. No.: 16/780,682

(22) Filed: Feb. 3, 2020

(30) Foreign Application Priority Data
Feb. 8, 2019 (JP) 2019-022084

(51) Int. Cl. G03G 15/00; G03G 21/00

(52) U.S. Cl. CPC G03G 15/80; G03G 21/0005

(57) ABSTRACT

An image forming apparatus includes an image forming unit including a photosensitive member and an optical scanning device including a transparent member that allows laser light for scanning the photosensitive member to pass through, wherein the image forming apparatus transitions between a first state in which image formation processing is able to be performed by the image forming unit and a second state in which power consumption is smaller than in the first state, a cleaning mechanism configured to clean the transparent member, and a control unit capable of executing a cleaning sequence for causing the cleaning mechanism to operate and configured to execute the cleaning sequence based on the image forming apparatus transitioning from the second state to the first state.

### BACKGROUND

### Field of the Disclosure

Aspects of the present disclosure generally relate to an image forming apparatus, such as an electrophotographic copying machine or a laser beam printer, which forms an image on a recording medium with use of an electrophotographic method.

### Description of the Related Art

A conventional image forming apparatus employing an electrophotographic method is equipped with an optical scanning device, which radiates laser light onto the surface of an electrically charged photosensitive member to form an electrostatic latent image on the photosensitive member. The optical scanning device includes optical system components, such as a light source and a mirror, a casing, which covers the optical system components, and an opening portion, through which light from the light source is output to outside the casing. Then, the opening portion is occluded by a transparent member, which allows light to pass therethrough, for the purpose of preventing a foreign substance such as toner or dust from intruding into the casing.

Here, in a case where a foreign substance, such as toner or dust, is present on the transparent member, light which is output through the opening portion is blocked by the foreign substance, so that a change in optical property occurs in the optical scanning device and, as a result, the quality of an image which is formed on a recording medium may decrease.

In this regard, Japanese Patent Application Laid-Open No. 2016-31467 discusses a configuration which performs cleaning processing to remove a foreign substance present on the transparent member with a cleaning member by moving the cleaning member while keeping the cleaning member in contact with the surface of the transparent member. Moreover, Japanese Patent Application Laid-Open No. 2016-31467 discusses a configuration which performs the above-mentioned cleaning processing on a periodic basis each time, for example, image formation on a predetermined number of sheets such as about 10,000 sheets is performed.

However, depending on a usage condition of the image forming apparatus, a foreign substance, such as toner, may fall onto the transparent member before the timing at which the cleaning processing is periodically performed.

For example, due to, for example, a vibration occurring during maintenance such as replacement of a replaceable unit removably provided in the image forming apparatus or an external vibration occurring when, for example, the image forming apparatus is relocated, a foreign substance, such as toner or paper dust, may fall onto the transparent member of an exposure unit.

If work which allows such a vibration to occur is performed in a state in which supplying of a power-supply voltage to the image forming apparatus is restricted, such as a state in which the power switch is turned off or a sleep state, the image forming apparatus cannot detect whether such work has been performed.

Accordingly, when image formation is performed after startup of the image forming apparatus or after returning from the sleep state, laser light which is emitted from the optical scanning device may be blocked by a falling foreign substance, so that the amount of laser light which is radiated onto a photosensitive member may decrease and, thus, the image quality may decrease.

### SUMMARY

Aspects of the present disclosure are generally directed to providing an image forming apparatus which is capable of preventing or reducing a decrease in image quality occurring after startup of the image forming apparatus or after returning from a sleep state thereof.

According to an aspect of the present disclosure, an image forming apparatus includes an image forming unit including a photosensitive member and an optical scanning device including a transparent member that allows laser light for scanning the photosensitive member to pass through, and configured to develop, with toner, an electrostatic latent image formed on the photosensitive member scanned by the laser light into a toner image and to form an image on a recording medium by transferring the toner image to the recording medium, wherein the image forming apparatus transitions between a first state in which image formation processing is able to be performed by the image forming unit and a second state in which power consumption is smaller than in the first state, a cleaning mechanism configured to clean the transparent member, and a control unit capable of executing a cleaning sequence for causing the cleaning mechanism to operate and configured to execute the cleaning sequence based on the image forming apparatus transitioning from the second state to the first state.

Further features of the present disclosure will become apparent from the following description of exemplary embodiments with reference to the attached drawings.

### BRIEF DESCRIPTION OF THE DRAWINGS

FIG. 1 is a schematic sectional view of an image forming apparatus.

FIGS. 2A, 2B, and 2C are explanatory diagrams used to explain a situation in which a replaceable cartridge is replaced.

FIG. 3 is a perspective view of an optical scanning device.

FIG. 4 is a top view of the optical scanning device.

FIG. 5 is a partial perspective view of a first cleaning holder.

FIG. 6 is a partial sectional view of the first cleaning holder.

FIG. 7 is a control block diagram illustrating a control configuration for executing a cleaning sequence.

FIG. 8 is a flowchart illustrating a cleaning sequence in a first exemplary embodiment.

FIG. 9 is a flowchart illustrating a cleaning sequence in a second exemplary embodiment.

### DESCRIPTION OF THE EMBODIMENTS

Various exemplary embodiments, features, and aspects of the disclosure will be described in detail below with reference to the drawings. Furthermore, for example, the dimension, material, shape, and relative location of each constituent component described in the following description are, unless specifically described, not intended to limit the scope of the disclosure only thereto.

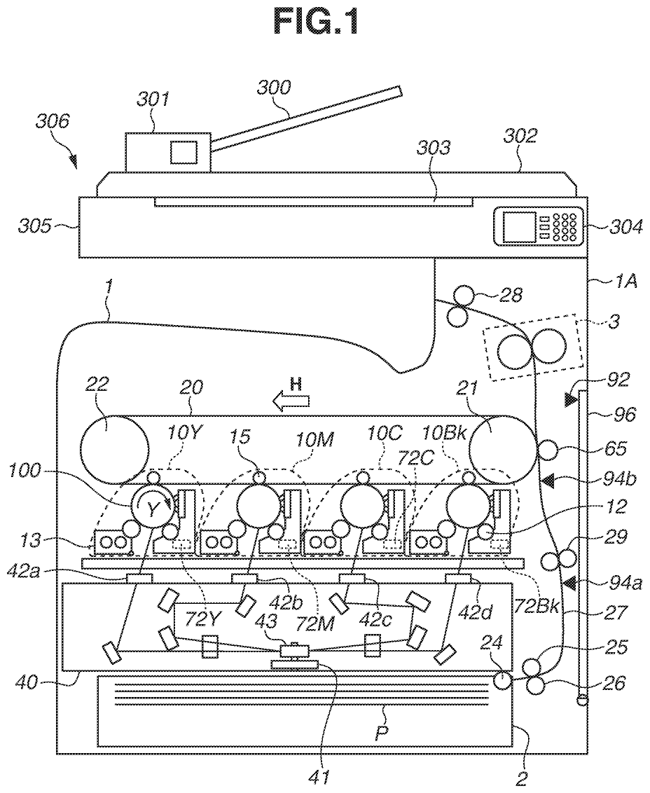

FIG. 1 is a schematic sectional view illustrating the overall configuration of an image forming apparatus 1 according to a first exemplary embodiment of the present disclosure. As illustrated in FIG. 1, the image forming apparatus 1 in the first exemplary embodiment is a color laser beam printer of the tandem type equipped with four image forming units 10Y, 10M, 10C, and 10Bk, which form toner images for respective colors of yellow (Y), magenta (M), cyan (C), and black (Bk).

Moreover, the image forming apparatus 1 in the first exemplary embodiment includes a reader unit 306 located in an upper portion of the apparatus main body 1A thereof. The reader unit 306 includes a document conveyance device 301, which automatically conveys a document, an image reading device 305, which reads an image of the conveyed document, and a document discharge tray 302, to which the document is discharged.

The document conveyance device 301 includes a document feeding tray 300, onto which a document is set. The document conveyance device 301 conveys a document placed on the document feeding tray 300 on a sheet-by-sheet basis to a document reading position on a glass 303 of the image reading device 305. The document conveyed onto the glass 303 is read by a scanner (not illustrated), such as a charge-coupled device (CCD) sensor or a contact image sensor (CIS), provided inside the image reading device 305. After that, the document conveyance device 301 further conveys the document, and then discharges the document onto the document discharge tray 302.

Moreover, the document conveyance device 301 is configured to be openable and closable with respect to the image reading device 305, so that the operator is allowed to open the document conveyance device 301 and then place a document on the glass 303.

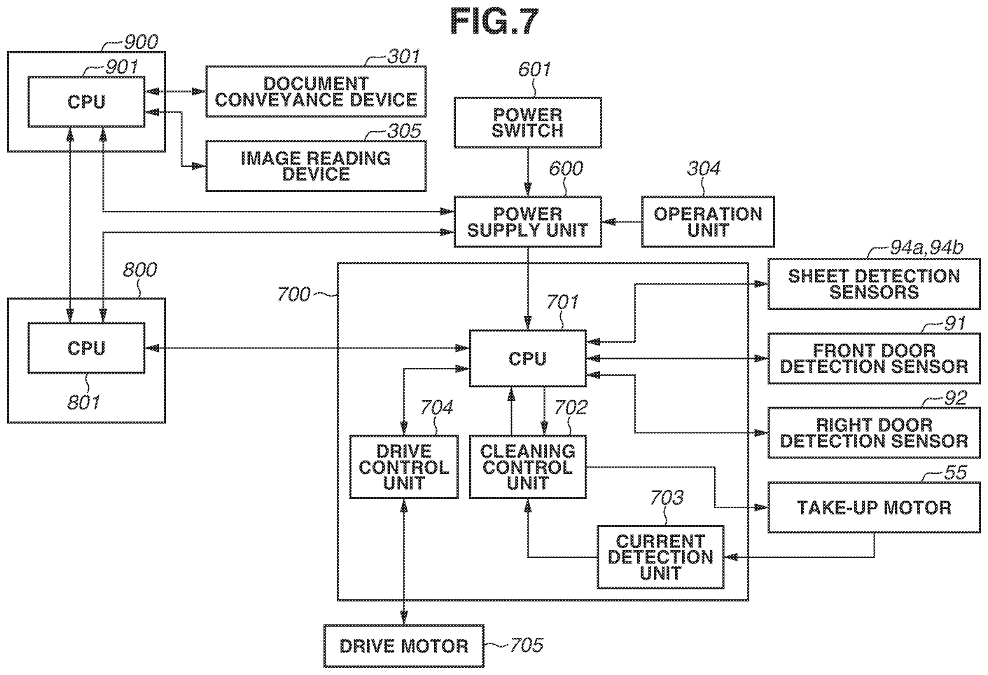

Then, the scanner causes a light source to radiate light to a document conveyed onto the glass 303 by the document conveyance device 301 or a document placed on the glass 303, causes a light receiving sensor to receive reflected light from the document, and converts the received light into an electrical signal. The scanner outputs electrical signals for red (r), green (g), and blue (b) components obtained by such conversion to a control unit, such as a central processing unit (CPU) 701 (FIG. 7) described below.

Moreover, as illustrated in FIG. 1, the image forming apparatus 1 in the first exemplary embodiment includes an operation unit 304. The operation unit 304 includes, for example, an operation panel which is configured with a display panel of the liquid crystal display type and a touch panel of the resistance film type of electrostatic capacitance type superposed on each other.

Therefore, the operation unit 304 is configured to allow the operator to perform an operation thereon via the touch panel based on information displayed on the display panel. The execution timing of an image forming operation and the execution timing of cleaning is able to be set or performed by the operator via the operation unit 304.

The operation unit 304 includes, for example, a start key, which is configured to be pressed to start an image forming operation, a stop key, which is configured to be pressed to stop the image forming operation, and a numeric keypad. Here, the numeric keypad includes keys which are configured to be operated to perform numerical entry of, for example, setting of the number of image-formed sheets. While, in the image forming apparatus in the first exemplary embodiment, a start key, a stop key, and a numeric keypad are provided as hardware keys on the operation unit 304, these keys can be displayed as software keys on the display panel.

The image forming apparatus 1 includes an intermediate transfer belt 20, to which toner images formed by the respective image forming units 10Y, 10M, 10C, and 10Bk are transferred. Then, the intermediate transfer belt 20 is configured to transfer the toner images superposed on the intermediate transfer belt 20 from the respective image forming units 10 to a sheet P, which is a recording medium, thus forming a color image on the sheet P (on a recording medium). Here, the recording medium as used in the first exemplary embodiment not only includes paper used for usual printing but also broadly includes, for example, cloth, plastic, and film.

Furthermore, the image forming units 10Y, 10M, 10C, and 10Bk have approximately the same configuration except for colors of toners used for the respective image forming units 10. In the subsequent description, the image forming unit 10Y is described an example of each image forming unit 10, and duplicate descriptions of the image forming units 10M, 10C, and 10Bk are omitted.

Each image forming unit 10 includes a photosensitive member 100, a charging roller 12, a developing device 13, and a primary transfer roller 15. The charging roller 12 electrically charges the photosensitive member 100 to a uniform background potential. The photosensitive member 100 allows an electrostatic latent image to be formed thereon by laser light emitted from an optical scanning device 40 described below. Moreover, the developing device 13 develops an electrostatic latent image formed on the photosensitive member 100 to form a toner image. Then, the primary transfer roller 15 transfers the toner image formed on the photosensitive member 100 to the intermediate transfer belt 20. Here, the primary transfer roller 15 forms a primary transfer portion between the photosensitive member 100 and the primary transfer roller 15 across the intermediate transfer belt 20, and receives a predetermined transfer voltage applied thereto to transfer the toner image formed on the photosensitive member 100 to the intermediate transfer belt 20.

The intermediate transfer belt 20 is formed in the shape of an endless belt, is suspended in a tensioned manner around a first belt conveyance roller 21 and a second belt conveyance roller 22, and is configured to rotationally operate in the direction of arrow H, so that toner images formed by the respective image forming units 10 are transferred to the intermediate transfer belt 20, which is rotating. Here, the four image forming units 10Y, 10M, 10C, and 10Bk are arranged side by side below the intermediate transfer belt 20 as viewed in vertical direction, so that toner images formed on the respective photosensitive members 100 according to image information for the respective colors are transferred to the intermediate transfer belt 20. Image forming processes for the respective colors which are performed by the image forming units 10 are performed at timing when each toner image is superposed on a toner image at the upstream side primarily transferred onto the intermediate transfer belt 20. As a result, toner images for the respective four colors are formed in a superposed manner on the intermediate transfer belt 20.

Moreover, the first belt conveyance roller 21 and a secondary transfer roller 65 are brought into pressure contact with each other across the intermediate transfer belt 20, and the first belt conveyance roller 21 forms a secondary transfer portion, which is provided for transferring toner images onto a sheet P, between the secondary transfer roller 65 and the first belt conveyance roller 21 across the intermediate transfer belt 20. When the sheet P passes through the secondary transfer portion, the toner images are transferred from the intermediate transfer belt 20 to the sheet P. Furthermore, transfer residual toner, which remains on the surface of the intermediate transfer belt 20, is recovered by a belt cleaning device (not illustrated).

Here, with regard to the image forming units 10 for the respective colors, the image forming unit 10Y, which forms a toner image for yellow, the image forming unit 10M, which forms a toner image for magenta, the image forming unit 10C, which forms a toner image for cyan, and the image forming unit 10Bk, which forms a toner image for black, are arranged in order from the upstream side with respect to the secondary transfer portion in the rotational direction of the intermediate transfer belt 20 (in the direction of arrow H).

Moreover, the optical scanning device 40, which performs scanning of laser light on the respective photosensitive members 100 and thus forms electrostatic latent images corresponding to image information on the respective photosensitive members 100, is located below the image forming units 10 as viewed in vertical direction. Here, the image forming units 10 and the optical scanning device 40 are an example of an image forming unit.

The optical scanning device 40 includes four semiconductor lasers (not illustrated), which emit laser beams modulated according to pieces of image information for the respective colors. Moreover, the optical scanning device 40 includes a motor unit 41 and a rotary polygonal mirror 43, which is rotated at high speed by the motor unit 41 in such a way as to deflect the laser beams emitted from the respective semiconductor lasers in a scanning manner along the rotational axis direction of each photosensitive member 100. The respective laser beams deflected by the rotary polygonal mirror 43 are guided by optical members located inside the optical scanning device 40 and are then emitted from the inside of the optical scanning device 40 to the outside thereof via transparent members 42a to 42d, which respectively cover opening portions provided at an upper portion of the optical scanning device 40. Then, the photosensitive members 100 are exposed to the respective laser beams emitted from the optical scanning device 40 to the outside thereof.

On the other hand, sheets P are stored in a sheet feeding cassette 2, which is located at a lower portion of the image forming apparatus 1. Then, a sheet P is fed by a pickup roller 24 to a separation nip portion formed by a conveyance roller 25 and a retard roller 26. Here, transmission of drive is configured in such a manner that the retard roller 26 rotates backward when a plurality of sheets P has been concurrently fed by the pickup roller 24, so that the retard roller 26 conveys sheets P on a sheet-by-sheet basis to the downstream side together with the conveyance roller 25, thus preventing double feeding of sheets P. The sheet P conveyed by the conveyance roller 25 and the retard roller 26 on a sheet-by-sheet basis is conveyed to a conveyance path 27, which extends approximately in a vertical fashion along the right lateral side of the image forming apparatus 1.

Then, the sheet P is conveyed from the lower side in vertical direction of the image forming apparatus 1 to the upper side in vertical direction of the image forming apparatus 1 through the conveyance path 27, and is then conveyed to a registration roller 29. The registration roller 29 temporarily stops the sheet P, which has been conveyed, and corrects skewing of the sheet P. After that, the registration roller 29 conveys the sheet P to the secondary transfer portion in conformity with timing at which the toner images formed on the intermediate transfer belt 20 are conveyed to the secondary transfer portion. After that, the sheet P to which the toner images have been transferred at the secondary transfer portion is conveyed to a fixing device 3, so that the toner images are pressed and heated by the fixing device 3 and are thus fixed to the sheet P. Then, the sheet P having the toner images fixed thereto is discharged by a discharge roller 28 to a discharge tray located outside the image forming apparatus 1 and in an upper portion of the main body of the image forming apparatus 1.

Here, the conveyance path 27 is formed from a pair of conveyance guides (not illustrated). Then, the pair of conveyance guides becomes separated by a right door 96 being opened relative to the apparatus main body 1A. In other words, When the right door 96 is opened, a conveyance guide provided on the side of the apparatus main body 1A and a conveyance guide provided on the side of the right door 96 become separated from each other, so that the conveyance guides are opened. This enables, when a conveyance abnormality, such as delay jam or stagnation jam, of the sheet P has occurred in the conveyance path 27, removing a sheet with respect to which an abnormality has occurred or a sheet the conveyance of which has been stopped due to the occurrence of a conveyance abnormality. Here, removing a sheet with respect to which an abnormality has occurred or a sheet the conveyance of which has been stopped due to the occurrence of a conveyance abnormality is an example of maintenance for the image forming apparatus 1.

Here, delay jam or stagnation jam is determined based on a result of detection performed by sheet detection sensors 94a and 94b. For example, when, after a predetermined time elapses since the sheet detection sensor 94a or 94b detects the leading edge (an end portion on the downstream side in the conveyance direction) of a sheet, the sheet detection sensor 94a or 94b still does not detect the trailing edge (an end portion on the upstream side in the conveyance direction) of the sheet, it is determined that stagnation jam has occurred. Moreover, when, after a predetermined time elapses since the sheet detection sensor 94a on the upstream side in the conveyance direction in the conveyance path 27 detects the leading edge of a sheet, the sheet detection sensor 94b on the downstream side in the conveyance direction still does not detect the leading edge of a sheet, it is determined that delay jam has occurred.

In this way, if it is determined that delay jam or stagnation jam has occurred, the image forming apparatus 1 stops conveyance of sheets P. Then, the image forming apparatus 1 issues a notification prompting the operator to remove a sheet P with respect to which a conveyance abnormality has occurred, by, for example, providing a display on the operation unit 304.

After that, the sheet P with respect to which a conveyance abnormality has occurred having been removed by the operator is detected based on the results of detection performed by the sheet detection sensors 94a and 94b having become off. Here, while, in the first exemplary embodiment, detection is performed in such a manner that the case where the sheet detection sensors 94a and 94b output an on-result indicates the presence of a sheet and the case where the sheet detection sensors 94a and 94b output an off-result indicates the absence of a sheet, the first exemplary embodiment is not limited to such a detection method. For example, a configuration in which the case where the sheet detection sensors 94a and 94b output an off-result indicates the presence of a sheet and the case where the sheet detection sensors 94a and 94b output an on-result indicates the absence of a sheet can be employed.

Moreover, the right door 96 being in a closed state with respect to the apparatus main body 1A is detected based on a result of detection performed by a right door detection sensor 92. When a conveyance abnormality has occurred in the conveyance path 27, a sheet P with respect to which the conveyance abnormality has occurred having been removed is determined based on the sheet detection sensors 94a and 94b outputting an off-result (detecting the absence of a sheet) after the closed state of the right door 96 is detected.

Furthermore, while, in the first exemplary embodiment, the right door 96 has been described as an example of an opening-and-closing member which is opened and closed with respect to the apparatus main body 1A, the same configuration can be applied to a door which is opened and closed with respect to the apparatus main body 1A when a sheet with respect to which a conveyance abnormality has occurred in another conveyance path is removed.

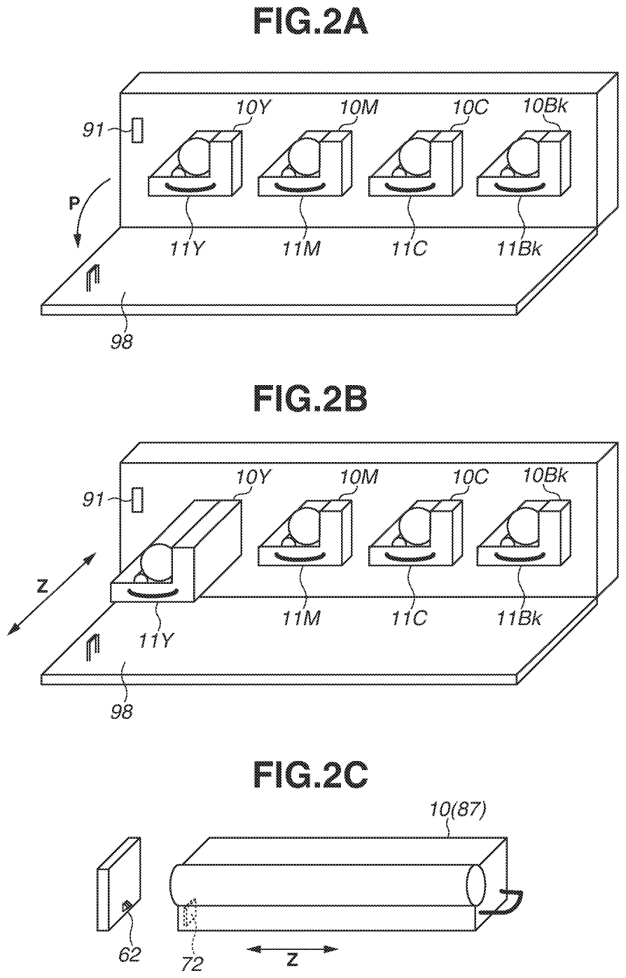

Next, a case where an image forming unit 10 is replaced as maintenance for the image forming apparatus 1 is described. FIGS. 2A, 2B, and 2C are explanatory diagrams used to explain a situation in which an image forming unit 10 is replaced with respect to the apparatus main body 1A.

The image forming unit 10 in the first exemplary embodiment is a cartridge attachable to and detachable from the apparatus main body 1A. Here, the attachable and detachable cartridge is a process cartridge in which the photosensitive member 100, the charging roller 12, and the developing device 13 are integrally included. While, in the first exemplary embodiment, a process cartridge is described as an example of a cartridge, a configuration in which a drum cartridge including the photosensitive member 100 and the charging roller 12 and a developing cartridge including the developing device 13 are individually attachable to and detachable from the apparatus main body 1A can be employed. Moreover, the attachable and detachable cartridge in the first exemplary embodiment is an example of a replaceable unit 87 described below.

Here, the image forming unit 10 is detached from the apparatus main body 1A when the replacement of a photosensitive member 100 or a developing roller is required due to, for example, aging. Then, a new image forming unit 10 is attached to the apparatus main body 1A, so that replacement of image forming units 10 is completed.

In this way, to replace an image forming unit 10, the operator opens a front door 98 in the direction of arrow P with respect to the apparatus main body 1A, as illustrated in FIG. 2A. In the image forming unit 10, since the front door 98 is opened, a grip portion 11, which is to be gripped to attach or detach the image forming unit 10, becomes exposed.

Then, when the operator cancels locking between the apparatus main body 1A and the image forming unit 10 made by a lock mechanism (not illustrated), the operator becomes able to pull out the image forming unit 10 from the apparatus main body 1A while gripping the grip portion 11.

Here, the opened or closed state of the front door 98 is able to be detected based on a result of detection performed by a front door detection sensor 91. In the first exemplary embodiment, the state in which the front door detection sensor 91 outputs an on-result is detected as the closed state of the front door 98, and the state in which the front door detection sensor 91 outputs an off-result is detected as the opened state of the front door 98.

FIG. 2B is a diagram illustrating a halfway state in which the image forming unit 10Y is being pulled out with respect to the apparatus main body 1A. As illustrated in FIG. 2B, in the first exemplary embodiment, the image forming unit 10 is configured to be attachable and detachable in the directions of double-headed arrow Z. Here, the directions of double-headed arrow Z are front-back directions of the image forming apparatus 1, and is parallel to the rotational axis direction of the photosensitive member 100.

When replacing an image forming unit 10, as mentioned above, the operator extracts the image forming unit 10 mounted in the apparatus main body 1A and then mounts a new image forming unit 10 into the apparatus main body 1A. Here, whether the image forming unit 10 has been replaced is determined by acquiring individual information stored in a read-only memory (ROM) 72 provided in the image forming unit 10.

As illustrated in FIG. 2C, the ROM 72 is provided on the downstream side in the mounting direction of the image forming unit 10. Then, in the apparatus main body 1A, an electrical contact 62 is provided at a position which faces the ROM 72 when the image forming unit 10 has been mounted. Therefore, when the image forming unit 10 is mounted, the ROM 72 and the electrical contact 62 are electrically connected to each other, so that the image forming apparatus 1 becomes able to acquire individual information about the image forming unit 10 stored in the ROM 72. The individual information acquired in this way is stored in a memory provided in the apparatus main body 1A. Then, in a case where individual information acquired after mounting (replacement) of the image forming unit 10 and individual information stored in the memory do not coincide with each other, the control unit can detect that the image forming unit 10 has been replaced.

In this way, since the image forming apparatus 1 has a configuration in which the image forming units 10 are located above the optical scanning device 40 as illustrated in FIG. 1, in some cases, a foreign substance, such as toner, paper dust, or mote, may fall onto the transparent members 42a to 42d, which are provided in an upper portion of the optical scanning device 40. In these cases, laser beams which are radiated toward the photosensitive members 100 via the transparent members 42a to 42d may be blocked by the foreign substance. Accordingly, a change in optical property may occur in the optical scanning device 40, so that the quality of an image to be formed may decrease in some cases.

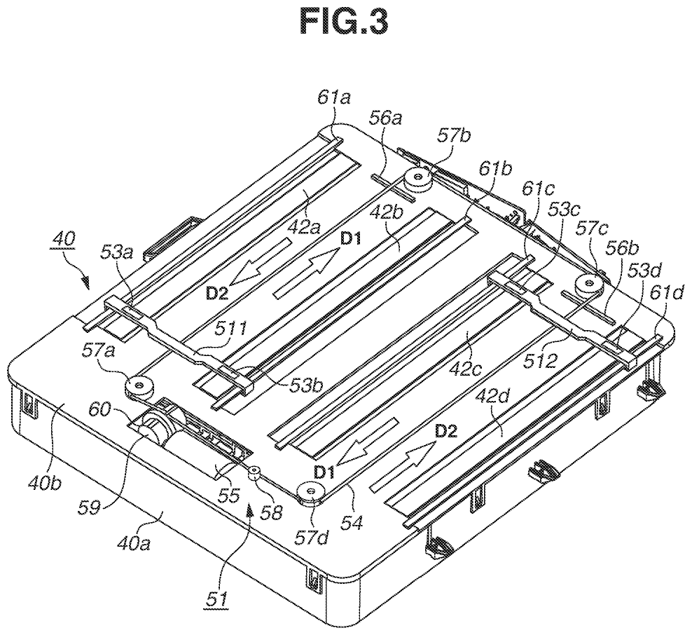

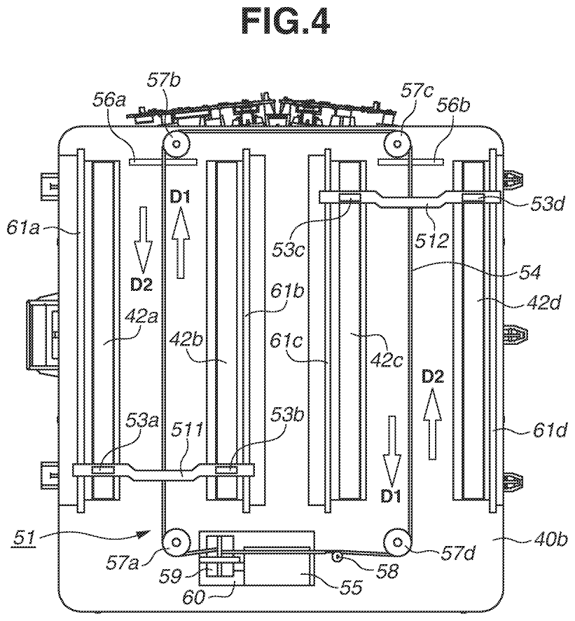

Therefore, in the first exemplary embodiment, the image forming apparatus 1 includes a cleaning mechanism 51, which is configured to clean the transparent members 42a to 42d of the optical scanning device 40. In the following description, the optical scanning device 40 and the cleaning mechanism 51, which is provided for the optical scanning device 40, are described in detail. FIG. 3 is a perspective view illustrating the entire optical scanning device 40, and FIG. 4 is a top view of the optical scanning device 40.

As illustrated in FIG. 3 and FIG. 4, the optical scanning device 40 includes a container portion 40a, which contains therein the above-mentioned motor unit 41 (FIG. 1) and the rotary polygonal mirror 43 (FIG. 1), and a cover portion 40b, which is attached to the container portion 40a and covers the top side of the container portion 40a. Here, the casing of the optical scanning device 40 is configured with the container portion 40a and the cover portion 40b.

The cover portion 40b is provided with four opening portions, through which laser beams pass with respect to the photosensitive members 100 for the respective colors, and each opening portion is of a rectangular shape elongated in the rotational axis direction of the associated photosensitive member 100 and the respective opening portions are formed in such a way as to extend in the longitudinal direction thereof in parallel with each other.

Then, the respective opening portions are occluded by the transparent members 42a to 42d, each of which is formed in an elongated rectangular shape. The transparent members 42a to 42d, the number of which is four as with the opening portions, are attached to the cover portion 40b in such a way as to extend in the longitudinal direction thereof in parallel with each other.

Furthermore, the longitudinal direction of each of the transparent members 42a to 42d is approximately equal to the scanning direction of laser light which is emitted from the optical scanning device 40. Moreover, in the first exemplary embodiment, the longitudinal direction of each of the transparent members 42a to 42d is approximately equal to the rotational axis direction of the associated one of the photosensitive members 100.

Here, the transparent members 42a to 42d are provided to prevent a foreign substance, such as toner, mote, or paper dust, from intruding into the optical scanning device 40, thus preventing a decrease in image quality from occurring due to a foreign substance adhering to, for example, the semiconductor laser, the mirrors, or the rotary polygonal mirror 43.

Each of the transparent members 42a to 42d is formed from a transparent material such as glass, and is configured to allow laser light emitted from the semiconductor laser contained in the container portion 40a to be radiated toward the photosensitive member 100. In the first exemplary embodiment, the size of each of the transparent members 42a to 42d is set larger than the opening of each opening portion, and the transparent members 42a to 42d are configured to cover the respective opening portions in an overlapping manner Then, the transparent members 42a to 42d are fixed to the cover portion 40b by bonding the overlapped portions of the transparent members 42a to 42d to the respective opening portions.

In this way, the optical scanning device 40 is configured to be covered by the cover portion 40b and the transparent members 42a to 42d in such a manner that a foreign substance, such as toner, paper dust, or mote, does not intrude into the optical scanning device 40. Moreover, since the transparent members 42a to 42d, each of which is larger than each opening portion, are bonded and fixed onto the cover portion 40b, a foreign substance, such as toner, paper dust, or mote, which may fall from above the optical scanning device 40, is prevented from intruding into the optical scanning device 40 through clearance gaps between the transparent members 42a to 42d and the respective opening portions.

Then, in the first exemplary embodiment, the image forming apparatus 1 includes the cleaning mechanism 51, which performs cleaning processing for cleaning off a foreign substance having fallen from above to the top surface of the optical scanning device 40 (the top surfaces of the transparent members 42a to 42d). Here, the top surfaces of the transparent members 42a to 42d are outside surfaces with respect to the optical scanning device 40 and are surfaces from which laser beams passing through the transparent members 42a to 42d exit.

The cleaning mechanism 51 is attached onto the cover portion 40b of the optical scanning device 40 at the side facing the image forming units 10. The cleaning mechanism 51 includes cleaning members 53a to 53d, which are configured to respectively clean the top surfaces of the transparent members 42a to 42d (the outer side surface of the optical scanning device 40), and a first cleaning holder 511 and a second cleaning holder 512, which hold the cleaning members 53a to 53d and move the cleaning members 53a to 53d on the transparent members 42a to 42d.

Each of the first cleaning holder 511 and the second cleaning holder 512 extends between two adjacent transparent members 42 in a direction perpendicular to the direction in which each transparent member 42 extends, and includes two cleaning members 53. Here, the number of cleaning members 53 included in the first cleaning holder 511 and the second cleaning holder 512 corresponds to the number of transparent members 42.

More specifically, the first cleaning holder 511 is located in such a way as to extend between the transparent members 42a and 42b, and includes the cleaning member 53a, which cleans the top surface of the transparent member 42a, and the cleaning member 53b, which cleans the top surface of the transparent member 42b. Moreover, the second cleaning holder 512 is located in such a way as to extend between the transparent members 42c and 42d, and includes the cleaning member 53c, which cleans the top surface of the transparent member 42c, and the cleaning member 53d, which cleans the top surface of the transparent member 42d.

Each of the cleaning members 53a to 53d is made from, for example, silicon rubber or unwoven cloth. The cleaning members 53a to 53d move while being in contact with the top surfaces of the transparent members 42 in conjunction with the movement of the first cleaning holder 511 and the second cleaning holder 512, so that the cleaning members 53a to 53d are able to remove foreign substances on the transparent members 42 and are thus able to clean the surface of the transparent members 42.

The first cleaning holder 511 has a central portion coupled to a wire 54, and is configured to hold the cleaning members 53a and 53b at both ends of the first cleaning holder 511 across the wire 54. Moreover, the second cleaning holder 512 has a central portion coupled to the wire 54, and is configured to hold the cleaning members 53c and 53d at both ends of the second cleaning holder 512 across the wire 54. Accordingly, the wire 54 is stretched in a tensioned state in such a way as to pass between the transparent members 42a and 42b and between the transparent members 42c and 42d.

Moreover, the wire 54 is stretched in a tensioned state in a circular manner on the cover portion 40b with use of four tensile stretching pulleys 57a to 57d, which are rotatably held on the cover portion 40b, a tension adjusting pulley 58, and a take-up drum 59. Then, the wire 54 is stretched in a tensioned state around the tensile stretching pulleys 57a to 57d in the state in which the length of the wire 54 was adjusted by the wire 54 being taken up a predetermined number of turns around the take-up drum 59 during assembly of the apparatus. At this time, as mentioned above, the four tensile stretching pulleys 57a to 57d are arranged in such a manner that the wire 54 passes between the transparent members 42a and 42b and between the transparent members 42c and 42d.

The tension of the wire 54 is adjusted by the tension adjusting pulley 58, which is located between the tensile stretching pulleys 57a and 57d. Therefore, the wire 54 is placed in a tensioned state without slack between the tensile stretching pulleys 57, the tension adjusting pulley 58, and the take-up drum 59. With this, since the wire 54 is stretched in a tensioned state, it is possible to cause the wire 54 to smoothly run in a circular way.

While, in the first exemplary embodiment, a configuration in which the tension adjusting pulley 58 is located between the tensile stretching pulleys 57a and 57d is employed, the location of the tension adjusting pulley 58 does not need to be limited to such a position as long as the position is available to adjust the tension of the wire 54 suspended in a tensioned manner around the tensile stretching pulleys 57a to 57d.

In this way, in the first exemplary embodiment, a configuration in which the first cleaning holder 511 is provided with the cleaning members 53a and 53b and the second cleaning holder 512 is provided with the cleaning members 53c and 53d is employed. On the other hand, in a case where one cleaning holder is provided with one cleaning member, a number of cleaning holders corresponding to the number of transparent members need to be provided, so that the length of the wire stretched in a tensioned state to move the cleaning holders becomes large. Accordingly, in the first exemplary embodiment, as compared with a configuration in which one cleaning member is held by one cleaning holder, it is possible to reduce the number of cleaning holders and it is possible to make the length of the wire 54 shorter, so that it is possible to clean the top surfaces of the transparent members 42a to 42d with a simpler configuration.

Moreover, the take-up drum 59 is configured to be able to be rotated by driving of a take-up motor 55 serving as a drive unit.

Here, the take-up motor 55 is configured to be able to rotate forward and backward. In the first exemplary embodiment, the forward rotation of the take-up motor 55 is set as the clockwise (CW) direction, and the backward rotation thereof is set as the counterclockwise (CCW) direction.

Accordingly, the wire 54 is configured to be taken up onto and paid out from the take-up drum 59 by the take-up drum 59 being rotated by the rotation of the take-up motor 55 in the CW direction or CCW direction. In this way, when being taken up and paid out by the take-up drum 59, the wire 54 is able to run in a circular manner on the cover portion 40bwhile being suspended in a tensioned manner by the tensile stretching pulleys 57.

Therefore, the first cleaning holder 511 and the second cleaning holder 512, which are coupled to the wire 54, are able to move in the directions of arrows D1 and D2 (along the longitudinal direction of each transparent member 42) in association with running of the wire 54. In the first exemplary embodiment, as the take-up motor 55 rotates in the CCW direction, the first cleaning holder 511 and the second cleaning holder 512 move in the direction of arrow D1. Moreover, as the take-up motor 55 rotates in the CW direction, the first cleaning holder 511 and the second cleaning holder 512 move in the direction of arrow D2.

At this time, since the wire 54 is stretched in a tensioned state in a circular manner, the first cleaning holder 511 and the second cleaning holder 512 are configured to move in the respective opposite directions in a linear manner along the longitudinal direction of each of the transparent members 42a to 42d in association with movement of the wire 54.

Here, the take-up motor 55 and the take-up drum 59 are located in a recessed portion 60, which is provided in such a way as to be recessed with respect to the top surface of the cover portion 40b. This enables reducing the size of the optical scanning device 40 in the height direction thereof. Furthermore, the recessed portion 60 does not communicate with the inside of the optical scanning device 40, so that a foreign substance also does not intrude into the optical scanning device 40 from the recessed portion 60.

Moreover, the cover portion 40b is provided with a first stopper 56a, which limits the movement of the first cleaning holder 511 in the longitudinal direction of each of the transparent members 42a and 42b (the rotational axis direction of each photosensitive member 100). Moreover, the cover portion 40b is also provided with a second stopper 56b, which limits the movement of the second cleaning holder 512 in the longitudinal direction of each of the transparent members 42c and 42d (the rotational axis direction of each photosensitive member 100). Here, each of the first stopper 56a and the second stopper 56b is an example of a contact member.

The first stopper 56a and the second stopper 56b are located at one end side in the longitudinal direction of each of the transparent members 42a to 42d. Accordingly, when the first cleaning holder 511 and the second cleaning holder 512 are moving in the direction of arrow D1, the first cleaning holder 511 arrives at the end portions of the transparent members 42a and 42b in the direction of arrow D1, thus coming into contact with the first stopper 56a.

With this, since the movement of the first cleaning holder 511 in the direction of arrow D1 is limited by the first stopper 56a, a load acting on the take-up motor 55, which rotates the take-up drum 59 to cause the wire 54 to run, becomes large. Such a load is detected with use of a current detection unit described below, so that the first cleaning holder 511 having arrived at the first stopper 56a is detected. At this time, the second cleaning holder 512 is situated at the side opposite to the side at which the first cleaning holder 511 is situated in the longitudinal direction of each of the transparent members 42.

Furthermore, a series of cleaning processing performed with the movement of the first cleaning holder 511 and the second cleaning holder 512 in the first exemplary embodiment is as follows.

First, when the take-up motor 55 is driven to rotate in the CW direction, the wire 54 runs in the direction of arrow D2, so that the first cleaning holder 511 and the second cleaning holder 512 move in the direction of arrow D2.

After that, the second cleaning holder 512 arrives at the end portions of the transparent members 42c and 42d in the direction of arrow D2, thus coming into contact with the second stopper 56b. With this, since the movement of the second cleaning holder 512 in the direction of arrow D2 is limited by the second stopper 56b, a load acting on the take-up motor 55, which rotates the take-up drum 59 to cause the wire 54 to run, becomes large. Such a load is detected with use of a current detection unit described below, so that the second cleaning holder 512 having arrived at the second stopper 56b is detected.

Then, when the second cleaning holder 512 having arrived at the second stopper 56b has been detected, the take-up motor 55 is stopped from rotating. At this time, the first cleaning holder 511 arrives at the other end side, i.e., at a second position, in the longitudinal direction of each of the transparent members 42. Accordingly, when the take-up motor 55 is stopped from rotating, the first cleaning holder 511 is stopped from moving at the second position in the longitudinal direction of each of the transparent members 42.

After that, the take-up motor 55 is rotated in the CCW direction, thus causing the wire 54 to run in the direction of arrow D1. With this, each of the first cleaning holder 511 and the second cleaning holder 512 moves in the direction of arrow D1.

After that, the first cleaning holder 511 arrives at the end portions of the transparent members 42a and 42b in the direction of arrow D1, thus coming into contact with the first stopper 56a. With this, since the movement of the first cleaning holder 511 in the direction of arrow D1 is limited by the first stopper 56a, a load acting on the take-up motor 55, which rotates the take-up drum 59 to cause the wire 54 to run, becomes large. Such a load is detected with use of a current detection unit described below, so that the first cleaning holder 511 having arrived at the first stopper 56a is detected.

Then, when the first cleaning holder 511 having arrived at the first stopper 56a has been detected, the take-up motor 55 is stopped from rotating in the CCW direction and is then rotated a predetermined number of rotations in the CW direction. With this, after the wire 54 is caused to run a predetermined distance in the direction of arrow D2, the take-up motor 55 is stopped from rotating.

In this way, in the first exemplary embodiment, each of the first cleaning holder 511 and the second cleaning holder 512 performing one reciprocating movement on the transparent members 42a to 42d is defined as a series of cleaning processing. Then, after the series of cleaning processing is ended, the wire 54 is caused to run a predetermined distance in the direction of arrow D2 and is then stopped, so that the operation of the first cleaning holder 511 is stopped at a position where the first cleaning holder 511 is not kept in contact with the first stopper 56a and the cleaning members 53 are not in contact with the surfaces of the transparent members 42.

In other words, the first cleaning holder 511 is stopped at a position in a non-passage region which is between the end portions of the transparent members 42 in the longitudinal direction of each of the transparent members 42 and the first stopper 56a and in which laser light does not pass through the transparent members 42. Furthermore, at this time, the second cleaning holder 512 is stopped at a position where the second cleaning holder 512 is not kept in contact with the end portions of the transparent members 42 in the longitudinal direction thereof, i.e., in a non-passage region in which laser light does not pass through the transparent members 42. Here, the stopping positions of the first cleaning holder 511 and the second cleaning holder 512 taken when a series of cleaning processing is ended are cleaning stopping positions and are thus cleaning start positions.

While, in the series of cleaning processing described above, a configuration in which, when the second cleaning holder 512 has arrived at the second stopper 56b, the take-up motor 55 is stopped from rotating and is then rotated in the CCW direction is employed, a configuration in which, in response to the second cleaning holder 512 arriving at the second stopper 56b, the take-up motor 55 is rotated in the CCW direction can be employed.

Furthermore, while, in the first exemplary embodiment, a configuration in which the take-up motor 55 is rotated forward (rotated in the CW direction) to cause the wire 54 to run in the direction of arrow D2 and the take-up motor 55 is rotated backward (rotated in the CCW direction) to cause the wire 54 to run in the direction of arrow D1 is employed, a configuration in which the take-up motor 55 is rotated forward to cause the wire 54 to run in the direction of arrow D1 and the take-up motor 55 is rotated backward to cause the wire 54 to run in the direction of arrow D2 can be employed.

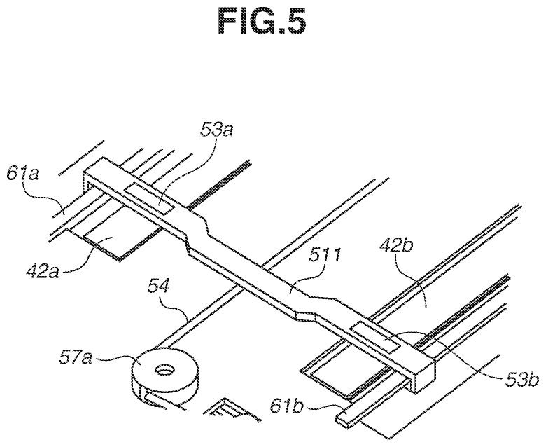

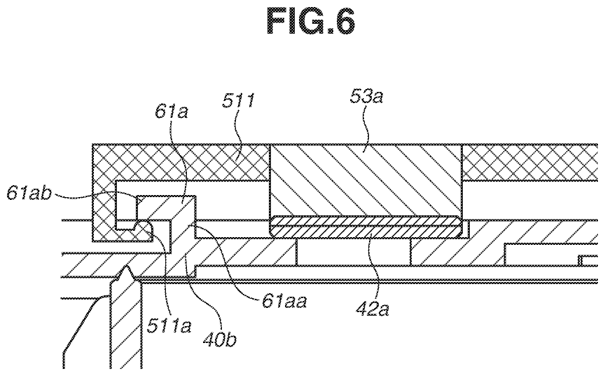

Moreover, the cover portion 40b is provided with guide members 61a to 61d, which are configured to guide the movement of the first cleaning holder 511 and the second cleaning holder 512. Then, as illustrated in FIG. 5 and FIG. 6, both end portions of the first cleaning holder 511 respectively engage with the guide members 61a and 61b.

Here, FIG. 5 is a partial perspective view illustrating the vicinity of the first cleaning holder 511. Furthermore, with regard to the second cleaning holder 512, as with the first cleaning holder 511, both end portions of the second cleaning holder 512 respectively engage with the guide members 61c and 61d. FIG. 6 is a partial sectional view illustrating an end portion at the side where the cleaning member 53a of the first cleaning holder 511 is held. While, here, only the configuration of the first cleaning holder 511 is described, in the first exemplary embodiment, the same configuration is assumed to be also used for the second cleaning holder 512.

As illustrated in FIG. 5 and FIG. 6, the guide members 61a to 61d are formed integrally with the cover portion 40b and are provided to project from the top surface of the cover portion 40b upward.

Here, each of the guide members 61a to 61d includes, as illustrated in FIG. 6, a first projecting portion 61aa, which projects from the top surface of the cover portion 40b upward, and a second projecting portion blab, which extends from the first projecting portion 61aa in a direction away from the cleaning member 53a.

Then, an end portion 511a at one side of the first cleaning holder 511 is formed in such a way as to get into under the second projecting portion 61ab. Here, the end portion 511a is configured to have a circular arc-like portion with which the second projecting portion 61ab is in contact. In this way, since the end portion 511a has a circular arc-like portion, it is possible to reduce a sliding resistance occurring when the first cleaning holder 511 moves in the direction of arrow D1 or the direction of arrow D2 (see FIG. 4).

Furthermore, while, in the first exemplary embodiment, only one end side of the first cleaning holder 511 is described in detail, the other end side thereof, i.e., the guide member 61b, is assumed to also have a similar configuration. Moreover, the second cleaning holder 512 is assumed to also have a similar shape.

Moreover, since the first cleaning holder 511 and the second cleaning holder 512 engage with the guide members 61a to 61d, it is possible to prevent or reduce the cleaning members 53a to 53d, which are held by the first cleaning holder 511 and the second cleaning holder 512, from moving in a direction away from the transparent members 42a to 42d. At this time, positions of engagement between the first cleaning holder 511 and the second cleaning holder 512 and the guide members 61a to 61d are set as positions where the cleaning members 53a to 53d are in contact with the transparent members 42a to 42d at a predetermined contact pressure.

Moreover, in the first exemplary embodiment, the guide members 61a to 61d, the first stopper 56a, and the second stopper 56b are configured to be formed from resin integrally with the cover portion 40b, but can be configured to be formed separately from the cover portion 40b.

As described above, in the first exemplary embodiment, moving the first cleaning holder 511 and the second cleaning holder 512 in the directions of arrow D1 and arrow D2, respectively, during cleaning processing enables cleaning the top surfaces of the transparent members 42a to 42d. Then, the cleaning processing is performed when an instruction for performing the cleaning processing has been received from the operator via, for example, the operation unit 304 at optional timing, or is periodically performed in response to the integrated number of image-formed sheets reaching a predetermined number of sheets.

Here, the predetermined number of sheets, based on which the cleaning processing is periodically performed, is previously set to, for example, 2,000 sheets as initial setting. With respect to such initial setting, the operator is able to set or change the predetermined number of sheets, based on which the cleaning processing is performed, by, for example, inputting a value in units of 500 sheets via the operation unit 304.

In the case of periodically performing cleaning processing, when the number of image-formed sheets reaches a predetermined number during execution of an image forming job, the image forming apparatus 1 temporarily stops the image forming job and then performs cleaning processing serving as a cleaning sequence for causing the cleaning mechanism 51 to operate.

As described above, periodically performing cleaning of the transparent members 42a to 42d in response to the cumulative number of image-formed sheets reaching a predetermined number enables preventing or reducing an image defect caused by a foreign substance falling onto the transparent members 42a to 42d.

However, a foreign substance such as toner falling onto the transparent members 42a to 42d is not limited to only during an image forming operation. For example, as mentioned above, due to a vibration occurring, for example, during maintenance for the image forming apparatus 1 or relocation of the image forming apparatus 1, a foreign substance, such as toner or paper dust, may fall onto the transparent members 42a to 42d. In other words, due to a vibration occurring, for example, in the case of attaching or detaching a replaceable cartridge such as the image forming unit 10 or in the case of removing a sheet with respect to which a conveyance abnormality has occurred in a conveyance path, a foreign substance may fall onto the transparent members 42a to 42d.

Therefore, it is conceivable to prevent or reduce a decrease in image quality in an image forming operation performed after maintenance by performing cleaning processing in response to maintenance being performed.

However, such maintenance is performed even in a state in which the functions of the image forming apparatus 1 are restricted (in a state other than a startup state), such as a case where a power-supply voltage to the control unit of the image forming apparatus 1 has been cut off or a case where the image forming apparatus 1 has transitioned to a sleep state in which some functions thereof are restricted (a second state). Here, in a case where a power-supply voltage to the control unit of the image forming apparatus 1 has been cut off or a case where the image forming apparatus 1 has transitioned to the sleep state, the image forming apparatus 1 becomes unable to acquire results of detection performed by sensors which are controlled by the control unit to which supplying of a power-supply voltage has been cut off.

Accordingly, in a case where supplying of a power-supply voltage to the control unit which controls, for example, the sheet detection sensors 94a and 94b, the front door detection sensor 91, and the right door detection sensor 92 has been cut off, the image forming apparatus 1 is unable to detect whether maintenance has been performed. Therefore, the image forming apparatus 1 is unable to perform cleaning processing in response to maintenance being performed, so that the image quality may decrease in an image forming operation which is performed after maintenance.

Therefore, in the first exemplary embodiment, in a case where the state in which the functions of the image forming apparatus 1 are restricted has been cancelled, the image forming apparatus 1 performs a cleaning sequence for cleaning the transparent members 42a to 42d. With this, even if, in a case where the functions of the image forming apparatus 1 are restricted, a foreign substance, such as toner or paper dust, falls onto the transparent members 42a to 42d, a decrease in image quality during image formation can be prevented or reduced.

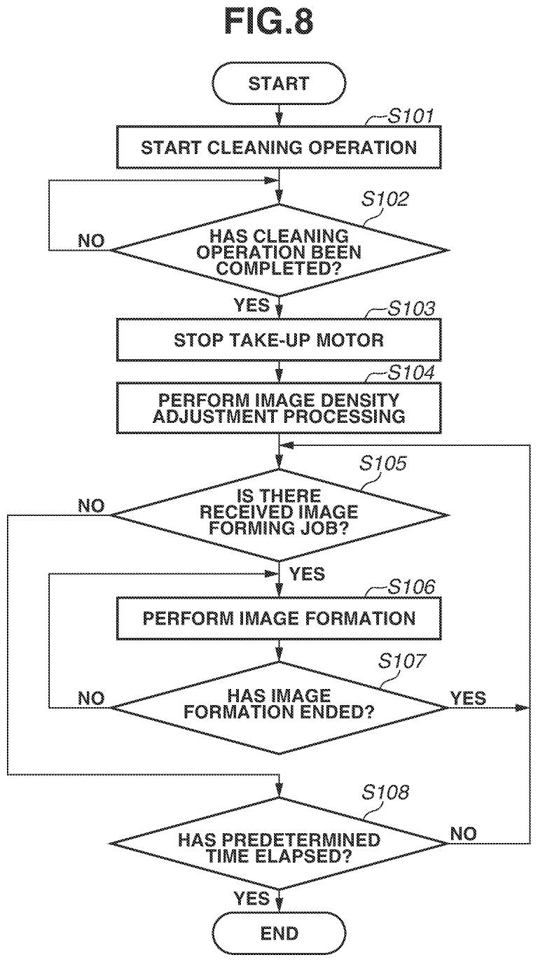

In the following description, a cleaning sequence in the first exemplary embodiment is described with reference to FIG. 7 and FIG. 8. Here, FIG. 7 is a control block diagram illustrating a control configuration for performing the cleaning sequence in the first exemplary embodiment. FIG. 8 is a flowchart illustrating the cleaning sequence in the first exemplary embodiment.

As illustrated in FIG. 7, the control configuration includes a power switch 601, serving as a main power-supply switch, which switches the state of supply of a power-supply voltage to each control unit of the image forming apparatus 1. When the power switch 601 is turned on by the operator in the state in which the image forming apparatus 1 is connected to a commercial power source via, for example, an electric outlet, a power-supply voltage is supplied to each control unit of the image forming apparatus 1 (a first state). Here, the power switch 601 is an example of a switch capable of cutting off supplying of a power-supply voltage.

In the first exemplary embodiment, the control configuration includes a power supply unit 600 which supplies a power-supply voltage to each control unit of the image forming apparatus 1 in a case where the power switch 601 is in an on-state. Here, when the power switch 601 is turned on, a power supply unit startup signal is output to the power supply unit 600, so that the power supply unit 600 is driven.

Moreover, in the first exemplary embodiment, the control configuration includes a DCON control unit 700, an SCON control unit 800, and an RCON control unit 900 as control units which receive power-supply voltages from the power supply unit 600 and control the image forming apparatus 1.

Here, the DCON control unit 700 performs control of drive units such as motors for driving, for example, various conveyance members and the image forming units 10 of the image forming apparatus 1 and sensors such as the sheet detection sensors 94a and 94b. The SCON control unit 800, which is a unit that performs system control of the entire image forming apparatus 1, performs control of communication with an external apparatus via an interface (not illustrated) and control of, for example, image processing. More specifically, the SCON control unit 800 is capable of performing, for example, control of reception of an image forming job, transmission of main body information about the image forming apparatus 1, and image processing on an image read by the image reading device 305 or image data received from, for example, an external apparatus. Moreover, the RCON control unit 900 performs various control operations of the document conveyance device 301 and the image reading device 305.

Here, the state in which the power switch 601 is turned on refers to a state in which the image forming apparatus 1 has been started up, in other words, a state in which commercial power is supplied to the power supply unit 600 via, for example, an electric outlet and power-supply voltages are supplied from the power supply unit 600 to the DCON control unit 700, the SCON control unit 800, and the RCON control unit 900.

Furthermore, in a case where the image forming apparatus 1 has been connected to, for example, a commercial power source via, for example, an electric outlet, the power supply unit 600 supplies, as an always-on power source, a power-supply voltage of +5 V to the SCON control unit 800. Then, in response to the power switch 601 being turned on, the power supply unit 600 becomes able to supply, as a non-always-on power source, power-supply voltages of +12 V and +24 V to the DCON control unit 700, the SCON control unit 800, and the RCON control unit 900. While, in the first exemplary embodiment, a configuration in which a plurality of types of voltages are supplied to control the respective control units is employed, the magnitudes or types of voltages do not need to be limited to those in such a configuration.

The DCON control unit 700 includes, as built-in modules, a CPU 701, a cleaning control unit 702, a current detection unit 703, and a drive control unit 704. Then, the CPU 701 controls the take-up motor 55 and a drive motor 705. Here, the drive motor 705 is a drive source for generating drive force for use in sheet conveyance and image forming operations of the image forming apparatus 1. Furthermore, while, in the first exemplary embodiment, the drive motor 705 is employed as an example, a configuration in which a plurality of motors is used to generate drive force for the fixing device 3 and drive force to be transmitted to the image forming units 10 can be employed. The DCON control unit 700 is an example of a control unit.

Moreover, the CPU 701 outputs a motor control signal to the take-up motor 55 via the cleaning control unit 702, thus driving the take-up motor 55 to rotate. In this way, the CPU 701 is able to control the take-up motor 55 via the cleaning control unit 702.

On the other hand, during a cleaning operation, the CPU 701 detects a motor driving current from the take-up motor 55 via the current detection unit 703.

Here, the take-up motor 55 is controlled with a fixed voltage. Accordingly, when the first cleaning holder 511 or the second cleaning holder 512 comes into contact with the first stopper 56a or the second stopper 56b, the motor driving current increases in response to a load acting on the take-up motor 55 becoming large.

Therefore, when the motor driving current detected by the current detection unit 703 has become larger than a predetermined value, the CPU 701 detects that the first cleaning holder 511 or the second cleaning holder 512 has come into contact with the first stopper 56a or the second stopper 56b. In other words, the CPU 701 detects that the movement in one way from end portions in the longitudinal direction of the transparent members 42a to 42d to the other end portions thereof has been ended. In other words, the CPU 701 detects that a cleaning operation in one way in the reciprocating movement has been ended.

Then, in response to detecting that the driving current for the take-up motor 55 has become larger than the above-mentioned predetermined value, the CPU 701 outputs a movement completion notification signal to the cleaning control unit 702. Upon receiving the movement completion notification signal, the cleaning control unit 702 stops rotational driving of the take-up motor 55.

Furthermore, the determination of ending of the movement of the first cleaning holder 511 and the second cleaning holder 512 from one end to the other end in the longitudinal direction of each of the transparent members 42a to 42d can be performed not by making a comparison with the predetermined value but by determining the amount of change of the driving current value flowing through the take-up motor 55.

Then, when it is determined that the reciprocating cleaning operation has been completed, the CPU 701 causes the cleaning control unit 702 to stop the take-up motor 55. Here, a configuration in which the completion of the cleaning operation is displayed on a display unit of the operation unit 304 via a user interface (not illustrated) can be employed. The notification of completion of the cleaning operation to the operator can be issued not by displaying a screen on the display unit but by emitting a sound, or such a notification itself can be omitted.

On the other hand, if it is determined that the reciprocating cleaning operation has not yet been completed, the CPU 701 outputs a cleaning execution instruction to the cleaning control unit 702 again, and causes the cleaning control unit 702 to control the take-up motor 55, thus continuing the cleaning operation. Furthermore, the cleaning control unit 702 is able to perform control to cause the first cleaning holder 511 and the second cleaning holder 512 to perform a reciprocating movement by causing the take-up motor 55 to rotate forward and backward.

Moreover, the front door detection sensor 91 and the right door detection sensor 92 are electrically connected to the CPU 701. The CPU 701 detects that the front door 98 is in a closed state based on an output from the front door detection sensor 91, and detects that the right door 96 is in a closed state based on an output from the right door detection sensor 92.

In the first exemplary embodiment, when the front door detection sensor 91 outputs an on-result, the CPU 701 detects that the front door 98 is in a closed state, and, when the front door detection sensor 91 outputs an off-result, the CPU 701 detects that the front door 98 is in an opened state. Moreover, when the right door detection sensor 92 outputs an on-result, the CPU 701 detects that the right door 96 is in a closed state, and, when the right door detection sensor 92 outputs an off-result, the CPU 701 detects that the right door 96 is in an opened state.

Moreover, the sheet detection sensors 94a and 94b are electrically connected to the CPU 701. The CPU 701 detects the presence or absence of a sheet in the conveyance path 27 based on outputs from the sheet detection sensors 94a and 94b. Then, the CPU 701 determines any conveyance abnormality, such as the above-mentioned stagnation jam or delay jam, based on the timing of detection performed by each of the sheet detection sensors 94a and 94b.

Then, in a case where such a conveyance abnormality for a sheet has been detected, the CPU 701 causes the drive control unit 704 to stop conveyance of the sheet and causes the operation unit 304 to issue a notification prompting the operator to remove the sheet in the conveyance path. After that, in response to the right door 96 transitioning from an opened state to a closed state, the CPU 701 determines whether a sheet is detected by the sheet detection sensors 94a and 94b. This is because, to remove a sheet in the conveyance path 27, it is necessary to open the right door 96 once and the right door 96 being closed indicates a high likelihood of the completion of removal of the sheet by the operator.

Moreover, in a case where a replaceable unit 87, such as the image forming unit 10, is mounted to the apparatus main body 1A, the CPU 701 is able to acquire individual information stored in the ROM 72 provided in the replaceable unit 87. Then, the CPU 701 writes the individual information acquired from the replaceable unit 87 in an electrically erasable programmable read-only memory (EEPROM) (not illustrated) included in the DCON control unit 700.

Here, the replaceable unit 87 is, for example, a process cartridge or developing cartridge such as that mentioned above, and is a unit which is to be replaced by the operator, for example, in a case where components included in the cartridge have abraded away due to aging. Moreover, the replaceable unit 87 is, for example, a toner bottle which contains toner to be supplied to a developing device in a container thereof and which is to be replaced by the operator when the amount of toner in the toner container becomes small. A notification prompting the operator to replace such a replaceable unit 87 is issued by the CPU 701 via the operation unit 304.

When, for example, the front door detection sensor 91 has detected a transition from an opened state to a closed state, the CPU 701 acquires individual information from the ROM 72 of the replaceable unit 87. This is because, to replace a replaceable unit 87, it is necessary to open the front door 98 and the front door detection sensor 91 detecting a transition of the front door 98 from an opened state to a closed state indicates a high likelihood of the completion of replacement of the replaceable unit 87.

Then, the CPU 701 compares individual information previously stored in a memory (not illustrated) before acquisition of individual information from the ROM 72 of the replaceable unit 87 with the new acquired individual information. At this time, if the individual information previously stored in the memory (not illustrated) before detection of the closed state of the front door 98 and the individual information newly acquired from the ROM 72 after detection of the closed state of the front door 98 coincide with each other, the CPU 701 detects that the replaceable unit 87 is not yet replaced. On the other hand, if the individual information previously stored in the memory (not illustrated) before detection of the closed state of the front door 98 and the individual information newly acquired from the ROM 72 after detection of the closed state of the front door 98 do not coincide with each other, the CPU 701 detects that the replaceable unit 87 has been replaced. Then, the CPU 701 stores the new acquired individual information in the memory (not illustrated).

While, in the first exemplary embodiment, a configuration in which the CPU 701, the cleaning control unit 702, the current detection unit 703, and the drive control unit 704 are incorporated in the DCON control unit 700 is employed, this configuration does not necessarily need to be employed. For example, a configuration in which the DCON control unit 700 performs control using modules different from the modules incorporated in the DCON control unit 700 described in the first exemplary embodiment can be employed.

Moreover, the SCON control unit 800, which includes a CPU 801, performs system control of the entire image forming apparatus 1 and control, such as image processing, of an image read by the image reading device 305. Since the SCON control unit 800 performs system control of the entire image forming apparatus 1, when the image forming apparatus 1 is connected to a commercial power source, a power-supply voltage (+5 V) is always supplied to the SCON control unit 800.

Then, the RCON control unit 900, which includes a CPU 901, performs control of the document conveyance device 301 and the image reading device 305. Here, the RCON control unit 900 outputs an image read via the image reading device 305 to the SCON control unit 800. With this, the SCON control unit 800 generates image processing information used for image formation which is performed by the DCON control unit 700 controlling, for example, the drive motor 705.

Furthermore, the DCON control unit 700, the SCON control unit 800, and the RCON control unit 900 are not limited to the ones configured as described above, but can be the ones including, for example, ASICs and other CPUs to perform respective control operations.

Here, the image forming apparatus 1 in the first exemplary embodiment is able to transition to a plurality of states, such as a startup state in which an image forming operation is enabled and a sleep state which is a power saving state in which supplying of a power-supply voltage to each control unit is restricted and the amount of power consumption is less than that in the state in which an image forming operation is enabled. Here, the startup state is a state in which the power switch 601 is turned on and is a state in which power-supply voltages are supplied to the DCON control unit 700, the SCON control unit 800, and the RCON control unit 900. In other words, the startup state is a state in which power-supply voltages are supplied to all of the control units and an image forming operation is enabled.

Moreover, the sleep state is a state in which, while a power-supply voltage is supplied to the SCON control unit 800, power-supply voltages to the DCON control unit 700 and the RCON control unit 900 are cut off.

Furthermore, a transition from the sleep state to the startup state and a transition from the startup state to the sleep state are effected by an operation performed by the operator, such as a sleep key (not illustrated) provided in the operation unit 304 being operated by the operator. At this time, when the sleep key of the operation unit 304 is operated, a sleep signal is output from the operation unit 304 to the power supply unit 600. With this, the power supply unit 600 controls each of the DCON control unit 700, the SCON control unit 800, and the RCON control unit 900 to make a transition to the sleep state. Moreover, the sleep state can be a state to which a transition is made from a power SW_ON state in a case where the image forming apparatus 1 is not operated for a predetermined time or more. The predetermined time as used herein can be, for example, a time previously set to, for example, 60 seconds or can be a time which is settable to an optional time by the operator.

Next, states of the image forming apparatus 1 in the first exemplary embodiment are described with reference to Table 1. Here, a power SW_ON state (startup state), in which the power switch 601 is tuned on, a sleep state, in which the amount of power consumption is smaller than the power SW_ON state, and a power SW_OFF state, in which the power switch 601 is tuned off, are described as an example.

Here, the sleep state and the power SW_OFF state are states in which power-supply voltages to be supplied are smaller in number than in the power SW_ON state (startup state) and functions to be performed are restricted. Furthermore, the power SW_ON state is an example of a first state in which image formation processing to be performed by the image forming apparatus 1 is enabled, and each of the sleep state and the power SW_OFF state is an example of a second state in which power consumption is smaller than in the first state.

These three states are described with reference to the following Table 1.

TABLE 1

| | | | | | | | | | Power |
|---|---|---|---|---|---|---|---|---|---|
| State | DCON | SCON | RCON | +24 V | +12 V | +5 V | HDD | Fixing | source fan |
| Power SW_ON | Y | Y | Y | Y | Y | Y | Y | Y | Y |
| Sleep | N | Y | N | Y | Y | Y | Y | N | Y |
| Power SW_OFF | N | Y | N | N | N | Y | N | N | N |

Y = voltage being supplied, and N = voltage not being supplied.

As mentioned above, in a case where the image forming apparatus 1 is connected to, for example, a commercial power source via, for example, an electric outlet, the power supply unit 600 supplies, as an always-on power source, a power-supply voltage of +5 V to the SCON control unit 800. Then, in response to the power switch 601 being turned on, the power supply unit 600 supplies, as a non-always-on power source, power-supply voltages of +12 V and +24 V, in addition to the power-supply voltage of +5 V, to the DCON control unit 700, the SCON control unit 800, and the RCON control unit 900.

As set forth in Table 1, in a case where the image forming apparatus 1 is in the power SW_ON state (startup state), since the power switch 601 is in an on-state, power-supply voltages of +5 V, +12 V, and +24 V are supplied to the SCON control unit 800, the DCON control unit 700, and the RCON control unit 900, respectively. Therefore, for example, a heating unit (not illustrated) of the fixing device 3, which is driven by the DCON control unit 700, and a power source fan which cools the power supply unit 600 are driven. In other words, in the power SW_ON state, all of the functions are able to be performed and image formation is enabled. Furthermore, in the first exemplary embodiment, the startup state refers to a state in which the power switch 601 is tuned on with the image forming apparatus 1 connected to a commercial power source and startup control such as a pre-rotation operation has been completed.

Next, the sleep state is described. In the sleep state, which is a state in which the power switch 601 is in an on-state, power-supply voltages of +5 V, +12 V, and +24 V are supplied to the power supply unit 600. Then, power-supply voltages of +5 V and +12 V are supplied from the power supply unit 600 to the SCON control unit 800.

Furthermore, in the sleep state, supplying of power-supply voltages to the DCON control unit 700 and the RCON control unit 900 is cut off. Thus, in the sleep state, the execution of the functions which are controlled by the DCON control unit 700 and the execution of the functions which are controlled by the RCON control unit 900 are restricted. In other words, in the sleep state, an image forming operation and an image reading operation are not able to be performed.

Moreover, in the sleep state, the SCON control unit 800, to which a power-supply voltage is supplied from the power supply unit 600, is, therefore, enabled to output an on/off signal to a power source fan (not illustrated) connected to the power supply unit 600 even in the sleep state. Then, the power source fan, to which a power-supply voltage of +12 V or +24 V is suppled from the power supply unit 600 under the control of the SCON control unit 800, is, therefore, enabled to be driven to rotate. In other words, even in the sleep state, the SCON control unit 800 is able to control the power source fan, which cools the power supply unit 600.

Moreover, the SCON control unit 800, to which a power-supply voltage is supplied from the power supply unit 600, is, therefore, able to control a hard disk drive (HDD), which stores, for example, image data and addresses.

On the other hand, in the power SW_OFF state, only a power-supply voltage of +5 V is supplied to the SCON control unit 800. Accordingly, in the power SW_OFF state, the amount of power consumption is smaller and the functions able to be performed are more restricted than in the sleep state.

Moreover, in the power SW_OFF state, supplying of power-supply voltages to the DCON control unit 700 and the RCON control unit 900 is cut off as with the sleep state. Thus, in the power SW_OFF state, the execution of the functions which are controlled by the DCON control unit 700 and the execution of the functions which are controlled by the RCON control unit 900 are restricted. In other words, in the power SW_OFF state, an image forming operation and an image reading operation are not able to be performed as with the sleep mode. Moreover, in the power SW_OFF state, since a power-supply voltage to be supplied to the SCON control unit 800 is lower than in the sleep state, the functions able to be performed are more restricted than in the sleep state.

More specifically, in the sleep state, since a power-supply voltage to be supplied to the SCON control unit 800 is higher, the HDD, which stores, for example, image data and addresses, and the power source fan, which cools the power supply unit 600, are enabled to be driven. On the other hand, in the power SW_OFF state, since a power-supply voltage to be supplied to the SCON control unit 800 is lower than in the sleep state, the HDD and the power source fan are disable to be driven. In this way, in the power SW_OFF state, since the functions able to be performed are more restricted than in the sleep state, the power-supply voltage to be supplied is lower and the amount of power consumption is smaller than in the sleep state.

As described above, in the first exemplary embodiment, the image forming apparatus 1 is configured to be able to transition from the startup state to the sleep state. This state transition is effected by the operator performing setting to the power saving state via the operation unit 304 as mentioned above. Moreover, a transition from the startup state to the sleep state is effected in a case where the state in which the image forming apparatus 1 is not operating has continued for a predetermined time or more.

Furthermore, with regard to the sleep state, a configuration in which the image forming apparatus 1 has not only a single sleep state but also a plurality of sleep states can be employed. For example, a configuration in which the image forming apparatus 1 has a first sleep state and a second sleep state in which the functions able to be performed are more restricted than in the first sleep state can be employed. In a case where, in this way, the image forming apparatus 1 has a plurality of sleep states, a configuration in which the operator is allowed to select a sleep state to which the startup state transitions in a case where the state in which the image forming apparatus 1 is not operating has continued for a predetermined time or more can be employed. Moreover, a configuration in which the startup state transitions to the first sleep state in a case where the image forming apparatus 1 is not operating for a predetermined time or more in the startup state and the first sleep state transitions to the second sleep state in a case where the image forming apparatus 1 is not operating for a further predetermined time or more in the first sleep state can be employed.

Moreover, a transition from the sleep state to the startup state is effected by the operator performing an operation such as operating the operation unit 304, as mentioned above. At this time, in response to the operation unit 304 being operated, the power supply unit 600 supplies power-supply voltages to the DCON control unit 700 and the RCON control unit 900. Furthermore, a configuration in which a transition from the sleep state to the startup state is effected in response to an image forming job being received or is effected in response to it being detected that the image forming apparatus 1 has been operated via a sensor (not illustrated) to which a power-supply voltage is suppled even during the sleep state can be employed.

Here, the sensor (not illustrated) is not a sensor which is controlled by the DCON control unit 700, such as the sheet detection sensor 94a or 94b, the front door detection sensor 91, or the right door detection sensor 92, but a sensor which is controlled by the SCON control unit 800. In other words, the sensor (not illustrated) is a sensor from which a detection result is able to be acquired by the SCON control unit 800 even during the sleep state.

Such a sensor is, for example, a sheet detection sensor which outputs an “on” signal when a sheet has been placed on a multi-feed tray (not illustrated) of the image forming apparatus 1. Moreover, such a sensor is, for example, a bottle cover detection sensor which outputs an “on” signal when a cover that covers a container portion in which a toner bottle used to supply toner to the image forming unit 10 is contained has been closed.

Furthermore, the states and the functions to be restricted set forth in Table 1 are merely examples, and another function can be restricted or the image forming apparatus 1 does not need to include all of the functions set forth in Table 1. For example, an image forming apparatus having a facsimile (FAX) function can include a configuration in which a power-supply voltage is supplied when the FAX function has been started up. Moreover, an image forming apparatus which does not include an image reading device and a document conveyance device can include a configuration in which an RCON control unit for controlling these devices is not provided.

Next, the cleaning sequence in the first exemplary embodiment is described with reference to FIG. 8. In the first exemplary embodiment, the flowchart of FIG. 8 is started when the image forming apparatus 1 has transitioned to the startup state in response to the power switch 601 of the image forming apparatus 1 being turned on or when the image forming apparatus 1 has returned from the sleep state to the startup state.

When the power switch 601 has been turned on or when the image forming apparatus 1 has returned from the sleep mode, power-supply voltages are supplied from the power supply unit 600 to the CPU 701 of the DCON control unit 700. Then, in step S101, the CPU 701, to which a power-supply voltage has been supplied, outputs a cleaning execution instruction to the cleaning control unit 702, thus performing a cleaning operation.

Then, in step S102, the CPU 701 determines whether the cleaning operation started in step S101 has been completed. Here, the determination as to whether the cleaning operation has been completed is made based on a result of detection performed by the current detection unit 703 as mentioned above. Furthermore, in the case of a configuration in which one cleaning operation is one reciprocating motion performed on the transparent members 42a to 42d, the cleaning operation is assumed to have been completed when one reciprocating motion has ended. Moreover, in the case of a configuration in which one cleaning operation is a movement from one end side to the other end side performed on the transparent members 42a to 42d, the cleaning operation is assumed to have been completed when the movement (the forward movement or the backward movement) has ended.

If it is determined that the cleaning operation has not yet been completed (NO in step S102), the CPU 701 continues the cleaning operation, and, if it is determined that the cleaning operation has been completed (YES in step S102), then in step S103, the CPU 701 outputs a movement completion signal to the cleaning control unit 702, thus stopping rotational driving of the take-up motor 55.

Then, in step S104, the CPU 701 performs image density adjustment processing. Here, the image density adjustment processing refers to processing for setting, for example, the amount of laser light of the optical scanning device 40 in such a way as to be able to form an image with an appropriate density even in a case where the image forming speed of the image forming apparatus 1 or the temperature of a surrounding environment has varied. In the image density adjustment processing, the CPU 701 detects the image density by forming a toner pattern for density detection on the intermediate transfer belt 20 with use of the image forming unit 10 and then reading the density of the formed toner pattern with a density detection sensor (not illustrated). Then, the CPU 701 changes the setting of the amount of laser light in such a manner that the detected image density becomes a predetermined density.

In this way, the image forming apparatus 1 in the first exemplary embodiment is able to adjust the density of an image to be formed by changing the intensity of laser light. Moreover, the image forming apparatus 1 performs the image density adjustment processing before executing the first image forming job in a case where the image forming apparatus 1 has transitioned from the sleep state or the power SW_OFF state to the startup state, thus preventing or reducing any decrease in the quality of an image to be formed after the image forming apparatus 1 is started up.

Then, in step S105, the CPU 701 determines whether there is an image forming job received from the operator via the operation unit 304 or an interface (not illustrated).

If it is determined that there is a received image forming job (YES in step S105), then in step S106, the CPU 701 controls the drive control unit 704 to perform image formation on a sheet. Then, in step S107, the CPU 701 determines whether an image forming operation concerning the image forming job received in step S105 has ended.

If it is determined that the image forming job received in step S105 has not yet ended (NO in step S107), the CPU 701 returns the processing to step S106, thus continuing the image forming operation.

Moreover, if it is determined that the image forming job received in step S105 has ended (YES in step S107), the CPU 701 returns the processing to step S105, thus determining whether there is a next received image forming job.

Then, if it is determined that there is no received image forming job (NO in step S105), then in step S108, the CPU 701 determines whether a predetermined time or more has elapsed since the image forming operation performed in step S106 has ended. If it is determined that the predetermined time or more has not yet elapsed since ending of the image forming operation (NO in step S108), the CPU 701 returns the processing to step S105, thus determining whether there is a received image forming job.

Moreover, if it is determined that the predetermined time or more has elapsed since ending of the image forming operation (YES in step S108), the CPU 701 ends the flowchart of FIG. 8 in response to supplying of a power-supply voltage from the power supply unit 600 being cut off. Thus, the image forming apparatus 1 transitions from the startup state to the sleep state.

While, in the flowchart of FIG. 8, the CPU 701 determines whether a predetermined time or more has elapsed since the image forming operation has ended, a configuration in which supplying of power-supply voltages from the power supply unit 600 is cut off based on whether a predetermined time or more has elapsed since a reading operation for an image has ended can be employed.

Furthermore, while, in the first exemplary embodiment, a configuration in which whether a predetermined time or more has elapsed since the image forming operation has ended is determined by the CPU 701 of the DCON control unit 700 has been described as an example, the first exemplary embodiment is not limited to this configuration. For example, a configuration in which the CPU 801 of the SCON control unit 800 determines a transition to the sleep state and thus cuts off supplying of power-supply voltages from the power supply unit 600 to the CPU 701 of the DCON control unit 700 can be employed. Moreover, a configuration in which the CPU 701 ends the flowchart of FIG. 8 when a sleep key (not illustrated) of the operation unit 304 has been operated can be employed. Moreover, a configuration in which, in a case where a transition to the sleep state is determined by the CPU 701, the CPU 701 communicates information indicating a predetermined time has elapsed to the CPU 801 or the power supply unit 600 to restrict supplying of power-supply voltages to the CPU 701 of the DCON control unit 700 can be employed.

In this way, in the first exemplary embodiment, since the image forming apparatus 1 performs a cleaning operation after starting up, even in a case where maintenance has been performed when supplying of power-supply voltages is restricted, such as when the power switch 601 of the image forming apparatus 1 is in an off-state or the image forming apparatus 1 is in the sleep state, the image forming apparatus 1 can prevent or reduce any decrease in the quality of an image which is formed in an image forming operation that is performed after maintenance. Moreover, even in a case where a vibration has occurred due to the image forming apparatus 1 being relocated when supplying of power-supply voltages is restricted, such as when the power switch 601 of the image forming apparatus 1 is in an off-state or the image forming apparatus 1 is in the sleep state, the image forming apparatus 1 can prevent or reduce any decrease in the quality of an image which is formed in an image forming operation that is performed after startup of the image forming apparatus 1.

Moreover, in the first exemplary embodiment, since, in a case where the image forming apparatus 1 has transitioned to the startup state, the image forming apparatus 1 performs a cleaning operation before performing image density adjustment processing, the image forming apparatus 1 can perform more accurate image adjustment.

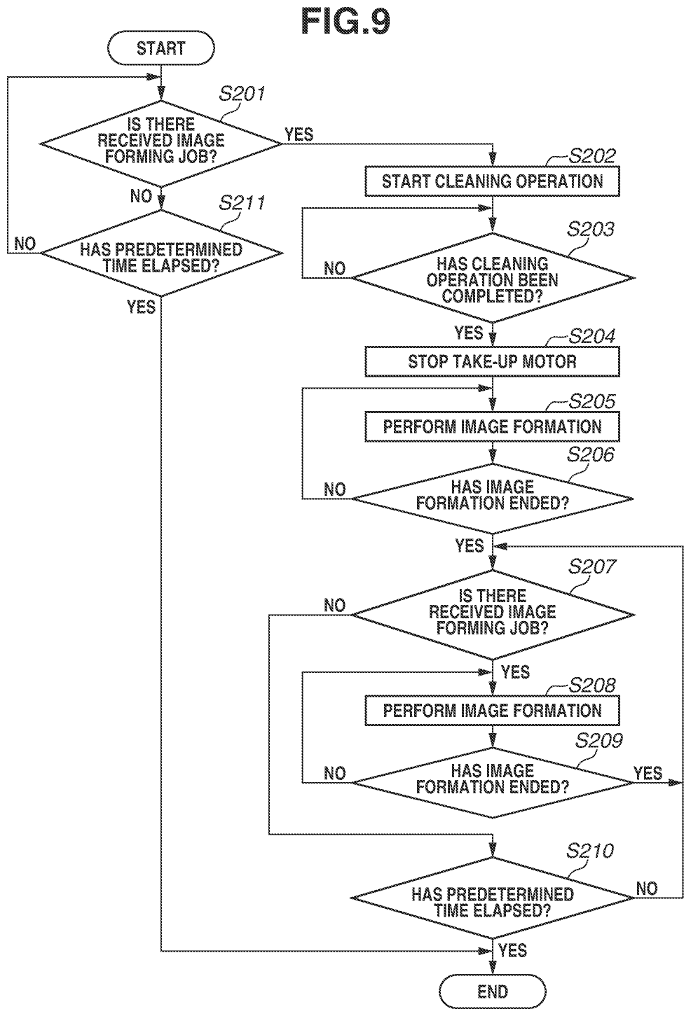

Next, a second exemplary embodiment of the present disclosure is described with reference to FIG. 9. The second exemplary embodiment differs from the first exemplary embodiment in timing at which to perform a cleaning sequence, and the other constituent elements of the second exemplary embodiment are similar to those of the first exemplary embodiment and are, therefore, assigned the respective same reference characters and omitted from description here.

FIG. 9 is a flowchart illustrating a cleaning sequence in the second exemplary embodiment. In the second exemplary embodiment, the flowchart of FIG. 9 is started when the image forming apparatus 1 has transitioned to the startup state in response to the power switch 601 of the image forming apparatus 1 being turned on or when the image forming apparatus 1 has returned from the sleep state to the startup state.

When the power switch 601 has been turned on or when the image forming apparatus 1 has returned from the sleep mode, power-supply voltages are supplied from the power supply unit 600 to the CPU 701 of the DCON control unit 700. Then, in step S201, the CPU 701, to which a power-supply voltage has been supplied, determines whether there is an image forming job received from the operator via the operation unit 304 or an interface (not illustrated).

If it is determined that there is a received image forming job (YES in step S201), then in step S202, the CPU 701 outputs a cleaning execution instruction to the cleaning control unit 702, thus performing a cleaning operation.

Then, in step S203, the CPU 701 determines whether the cleaning operation started in step S202 has been completed. Here, the determination as to whether the cleaning operation has been completed is made based on a result of detection performed by the current detection unit 703 as mentioned above. Furthermore, in the case of a configuration in which one cleaning operation is one reciprocating motion performed on the transparent members 42a to 42d, the cleaning operation is assumed to have been completed when one reciprocating motion has ended. Moreover, in the case of a configuration in which one cleaning operation is a movement from one end side to the other end side performed on the transparent members 42a to 42d, the cleaning operation is assumed to have been completed when the movement (the forward movement or the backward movement) has ended.

If it is determined that the cleaning operation has not yet been completed (NO in step S203), the CPU 701 continues the cleaning operation, and, if it is determined that the cleaning operation has been completed (YES in step S203), then in step S204, the CPU 701 outputs a movement completion signal to the cleaning control unit 702, thus stopping rotational driving of the take-up motor 55.

Then, in step S205, the CPU 701 controls the drive control unit 704 to perform image formation on a sheet. Then, in step S206, the CPU 701 determines whether an image forming operation concerning the image forming job received in step S201 has ended.

If it is determined that the image forming job received in step S201 has not yet ended (NO in step S206), the CPU 701 returns the processing to step S205, thus continuing the image forming operation.

Moreover, if it is determined that the image forming job received in step S201 has ended (YES in step S206), then in step S207, the CPU 701 determines whether there is a next received image forming job.

If it is determined that there is a next received image forming job (YES in step S207), then in step S208, the CPU 701 controls the drive control unit 704 to perform image formation on a sheet. Then, in step S209, the CPU 701 determines whether an image forming operation concerning the image forming job received in step S207 has ended.

If it is determined that the image forming job received in step S207 has not yet ended (NO in step S209), the CPU 701 returns the processing to step S208, thus continuing the image forming operation.

Moreover, if it is determined that the image forming job received in step S207 has ended (YES in step S209), the CPU 701 returns the processing to step S207, thus determining whether there is a next received image forming job.

Then, if it is determined that there is no received image forming job (NO in step S207), then in step S210, the CPU 701 determines whether a predetermined time or more has elapsed since the image forming operation performed in step S208 has ended. If it is determined that the predetermined time or more has not yet elapsed since ending of the image forming operation (NO in step S210), the CPU 701 returns the processing to step S207, thus determining whether there is a received image forming job.

Moreover, if it is determined that the predetermined time or more has elapsed since ending of the image forming operation (YES in step S210), the CPU 701 ends the flowchart of FIG. 9 in response to supplying of a power-supply voltage from the power supply unit 600 being cut off. Thus, the image forming apparatus 1 transitions from the startup state to the sleep state.

Furthermore, if, in step S201, it is determined that no image forming job is received after the image forming apparatus 1 transitions to the startup state with the power switch 601 of the image forming apparatus 1 tuned on or after the image forming apparatus 1 returns from the sleep state to the startup state (NO in step S201) and, in step S211, it is determined that a time in which no image forming job is received after the image forming apparatus 1 transitions to the startup state continues for a predetermined time or more (YES in step S211), the CPU 701 ends the flowchart of FIG. 9.

Then, if, after that, the image forming apparatus 1 transitions to the startup state, the flowchart of FIG. 9 is started again, and, if, at that time, it is determined that the image forming apparatus 1 has received an image forming job (YES in step S201), then in step S202, the CPU 701 issues an instruction to perform a cleaning operation. With this, even when the image forming apparatus 1 has returned from the sleep state to the startup state or has transitioned to the startup state with the power switch 601 turned on, the image forming apparatus 1 does not perform a cleaning operation until executing an image forming job (until receiving an image forming job). This enables preventing or reducing execution of an unnecessary cleaning sequence. Then, this enables preventing or reducing abrasion of the cleaning members 53 and also enables preventing or reducing an increase in power consumption caused by an unnecessary operation being performed.

Furthermore, while, in the second exemplary embodiment, a configuration in which whether a predetermined time or more has elapsed since the image forming operation has ended is determined by the CPU 701 of the DCON control unit 700 has also been described as an example as with the first exemplary embodiment, the second exemplary embodiment is not limited to this configuration. For example, a configuration in which the CPU 801 of the SCON control unit 800 determines a transition to the sleep state and thus cuts off supplying of power-supply voltages from the power supply unit 600 to the CPU 701 of the DCON control unit 700 can be employed. Moreover, a configuration in which the CPU 701 ends the flowchart of FIG. 9 when a sleep key (not illustrated) of the operation unit 304 has been operated can be employed. Moreover, a configuration in which, in a case where a transition to the sleep state is determined by the CPU 701, the CPU 701 communicates information indicating a predetermined time has elapsed to the CPU 801 or the power supply unit 600 to restrict supplying of power-supply voltages to the CPU 701 of the DCON control unit 700 can be employed.

In this way, in the second exemplary embodiment, since the image forming apparatus 1 performs a cleaning operation after starting up, even in a case where maintenance has been performed when supplying of power-supply voltages is restricted or the image forming apparatus 1 is in the sleep state, the image forming apparatus 1 can prevent or reduce any decrease in the quality of an image which is formed in an image forming operation that is performed after maintenance.

Moreover, in the second exemplary embodiment, since the image forming apparatus 1 performs a cleaning operation before execution of an image forming job which is to be first executed after the image forming apparatus 1 transitions to the startup state, even in a case where maintenance has been performed when supplying of power-supply voltages is restricted, such as when the power switch 601 of the image forming apparatus 1 is in an off-state or the image forming apparatus 1 is in the sleep state, the image forming apparatus 1 can prevent or reduce any decrease in the quality of an image which is formed in an image forming operation that is performed after maintenance.

Moreover, even in a case where a vibration has occurred due to the image forming apparatus 1 being relocated when supplying of power-supply voltages is restricted, such as when the power switch 601 of the image forming apparatus 1 is in an off-state or the image forming apparatus 1 is in the sleep state, the image forming apparatus 1 can prevent or reduce any decrease in the quality of an image which is formed in an image forming operation that is performed after startup of the image forming apparatus 1.

While, in the above-described exemplary embodiments, a configuration in which the optical scanning device 40 is located below the image forming units 10 as viewed in vertical direction has been described, a configuration in which the optical scanning device 40 is located above the image forming units 10 as viewed in vertical direction can be employed. In the case of this configuration, since the transparent members 42a to 42d are provided above the image forming units 10, for example, toner or paper dust does not fall from the image forming units 10 to the transparent members 42a to 42d, but flying toner or paper dust may adhere to the transparent members 42a to 42d. Therefore, even in a configuration in which the optical scanning device 40 is located above the image forming units 10 as viewed in vertical direction, providing the cleaning mechanism 51 enables removing a foreign substance, such as toner or paper dust, adhering to the transparent members 42a to 42d.

Moreover, while, in the above-described exemplary embodiments, a configuration in which the image forming apparatus 1 receives an image forming job from the operator via the operation unit 304 has been described, the above-described exemplary embodiments can also be applied to a configuration in which the image forming apparatus 1 receives an image forming job from an external apparatus via a communication line.

Moreover, while, in the above-described exemplary embodiments, a configuration in which the image forming apparatus 1 performs cleaning processing when the image forming apparatus 1 has transitioned to the startup state is employed, the above-described exemplary embodiments do not need to be limited to this configuration. For example, the image forming apparatus 1 can be configured to perform cleaning processing when the image forming apparatus 1 has transitioned to the startup state and it has been detected that a replaceable unit has been replaced. Moreover, the image forming apparatus 1 can be configured to perform cleaning processing when the image forming apparatus 1 has transitioned to the startup state and a conveyance abnormality has been resolved.

Furthermore, with regard to cleaning processing in the above-described exemplary embodiments, not only a configuration in which the image forming apparatus 1 performs a cleaning operation when the image forming apparatus 1 has transitioned from the power SW_OFF state or the sleep state to the startup state but also a configuration in which the image forming apparatus 1 performs a cleaning operation in response to an image forming operation having been performed by the image forming units 10 for a predetermined number of sheets can be employed. In this case, after performing a cleaning operation when the image forming apparatus 1 has transitioned from the power SW_OFF state or the sleep state to the startup state, the image forming apparatus 1 can reset the value of a counter which counts the number of image-formed sheets for the purpose of performing a cleaning operation. This enables preventing or reducing such a decrease in usability that a cleaning operation may be frequently performed.

According to exemplary embodiments of the present disclosure, an image forming apparatus which is capable of preventing or reducing a decrease in image quality occurring after startup of the image forming apparatus or after returning from a sleep state thereof can be provided.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of priority from Japanese Patent Application No. 2019-022084 filed Feb. 8, 2019, which is hereby incorporated by reference herein in its entirety.

What is claimed is:

1. An image forming apparatus comprising:
an image forming unit including a photosensitive member and an optical scanning device including a transparent member that allows laser light for scanning the photosensitive member to pass through, and configured to develop, with toner, an electrostatic latent image formed on the photosensitive member scanned by the laser light into a toner image and to form an image on a recording medium by transferring the toner image to the recording medium, wherein the image forming apparatus transitions between a first state in which image formation processing is able to be performed by the image forming unit and a second state in which power consumption is smaller than in the first state;
a cleaning mechanism configured to clean the transparent member; and
a control unit capable of executing a cleaning sequence for causing the cleaning mechanism to operate and configured to execute the cleaning sequence based on the image forming apparatus transitioning from the second state to the first state.

2. The image forming apparatus according to claim 1, wherein a number of executable functions in the second state is less than a number of executable functions in the first state.

3. The image forming apparatus according to claim 1,
wherein the control unit includes a first control unit configured to perform drive control of the image forming unit, a second control unit configured to perform image processing control of an image which is formed by the image forming unit, and a power supply unit configured to control supplying of power-supply voltages to the first control unit and the second control unit,
wherein the first state is a state in which power-supply voltages are supplied to the first control unit and the second control unit by the power supply unit, and
wherein the second state is a state in which a power-supply voltage is supplied to only the first control unit by the power supply unit.

4. The image forming apparatus according to claim 1, wherein the image forming apparatus transitions from the first state to the second state in a case where no operation is performed by an operator on the image forming apparatus for a duration of time equal to or greater than a predetermined time.

5. The image forming apparatus according to claim 3, further comprising a switch capable of cutting off supplying of a power-supply voltage to the second control unit,
wherein the image forming apparatus transitions from the first state to the second state when the switch is turned off.

6. The image forming apparatus according to claim 5, wherein the control unit executes the cleaning sequence when the switch is turned on.

7. The image forming apparatus according to claim 1, wherein the control unit executes the cleaning sequence before execution of an image forming operation by the image forming unit in a case where the image forming apparatus has transitioned from the second state to the first state.

8. The image forming apparatus according to claim 1, wherein the control unit executes the cleaning sequence before execution of density adjustment processing by the image forming unit in a case where the image forming apparatus has transitioned from the second state to the first state.
